(19) United States
(12) Patent Application Publication
(10) Pub. No.: US 2020/0228056 A1
(43) Pub. Date: Jul. 16, 2020

(54) Backpack with Modular Solar Panel

(71) Applicant: RWM Manufacturing, LLC, St. Louis, MO (US)

(72) Inventor: Robert W. Miller, St. Louis, MO (US)

(21) Appl. No.: 16/741,219

(22) Filed: Jan. 13, 2020

Related U.S. Application Data
(60) Provisional application No. 62/791,284, filed on Jan. 11, 2019.

(51) Int. Cl. H02S 30/20; H02S 20/30; H02S 10/20; H02S 40/38; H02J 7/04; A45F 3/04

(52) U.S. Cl. CPC H02S 30/20; H02S 20/30; H02S 10/20; A45B 2200/1027; H02J 7/04; A45F 3/04; H02S 40/38

(57) ABSTRACT

A system for providing solar charging capabilities is described. The system for providing solar charging capabilities may comprise a backpack having a first pocket and an outer surface; a first solar panel being mounted onto the outer surface of the backpack; a battery being placed into the first pocket, wherein the battery is configured to be electrically connected to more than one solar panel. By providing such a backpack, a user of the backpack may charge electronic device while using the backpack or while the backpack is at rest.

### CROSS-REFERENCE TO RELATED APPLICATIONS

This application claims the benefit of U.S. Provisional Patent Application No. U.S. 62/791,284 titled Backpack with Modular Solar Panel, filed Jan. 11, 2019, the entire contents of which are hereby incorporated by reference herein.

### BACKGROUND

### 1. Field of the Invention

The invention relates generally to backpacks and specifically to backpacks that include a solar panel to provide for energy generation.

### 2. Description of the Related Art

The world's daily use and dependence on electronic devices keeps increasing. Whether these daily users are going to work, school, or traveling, they need to keep their electronic devices powered up. Their electronic devices keep them connected to family and friends, as well as to the world around them.

While these electronic devices are great, they have a finite amount of energy. Very often there are circumstances where these devices need to be recharged while on the go. Finding a convenient place to charge these devices and/or carrying with them enough extra energy, be it additional chemical batteries or some other energy source, can prove to be cumbersome and inefficient.

The current environmental climate crisis has also led these same users to look for products where they can personally make a positive environmental impact while at the same time not negatively affect their day to day activities. This often means integrating as many functions as possible into single units, so as to maximize the usefulness of any single unit.

### SUMMARY OF THE INVENTION

The following is a summary of the invention, which should provide to the reader a basic understanding of some aspects of the invention. This summary is not intended to identify critical elements of the invention or, in any way, to delineate the scope of the invention. The sole purpose of this summary is to present in simplified text some aspects of the invention as a prelude to the more detailed description presented below.

Because of these and other problems in the art, described herein, among other things, is a system for providing solar charging capabilities. The system may comprise: a backpack having a first pocket and an outer surface; a first solar panel mounted onto the outer surface of the backpack; a battery placed into the first pocket, wherein the battery is configured to be electrically connected to more than a single solar panel.

In an embodiment of the system, the system may further comprise a second solar panel, wherein the second solar panel is placed with a second pocket of the backpack.

In an embodiment of the system, the system is configured so that the first solar panel and the second solar panel may be connected to the battery in series.

In an embodiment of the system, the system is configured so that the first solar panel and the second solar panel may be connected to the battery in parallel.

In an embodiment of the system, the first solar panel and the second solar panel are configured to supply power equal to or more than about 21 watts.

In an embodiment of the system, the first solar panel is flexible.

In an embodiment of the system, the first solar panel is mechanically sewn into the outer surface of the backpack.

In an embodiment of the system, the battery is in wireless electrical communication with the first solar panel.

In an embodiment of the system, the battery is in wired electrical communication with the first solar panel.

In an embodiment of the system, the outer surface of the backpack is separable from the backpack.

In an embodiment of the system, the system further comprises a charge regulating circuit.

In an embodiment of the system, the charge regulating circuit is located proximate to the battery.

In an embodiment of the system, the charge regulating circuit is located proximate to the solar panel.

In an embodiment of the system, the charge regulating circuit is located within the backpack.

In an embodiment of the system, the battery is a chemical battery.

In an embodiment of the system, the solar panel and the outer surface of the backpack are configured to allow for solar charging during use of the backpack.

In an embodiment of the system, the solar panel may be hidden from view during use of the backpack.

In an embodiment of the system, the solar panel may be hidden by rolling up the solar panel.

In an embodiment of the system, the solar panel comprises mono-crystalline silicon.

In an embodiment of the system, the backpack comprises a ripstop fabric.

### BRIEF DESCRIPTION OF THE DRAWINGS

FIG. 1 depicts a first embodiment of a backpack with a modular solar panel.

FIG. 2 depicts a second embodiment of a backpack with a modular solar panel.

FIG. 3 depicts a third embodiment of a backpack with a modular solar panel deployed.

FIG. 4 depicts the embodiment of FIG. 3 with the modular solar panel stowed.

FIG. 5 depicts a fourth embodiment of a backpack with a modular solar panel.

FIGS. 6 and 7 depict additional views of the embodiment of FIG. 1.

### DETAILED DESCRIPTION OF THE PREFERRED EMBODIMENT(S)

The following detailed description is believed to be of the best current mode(s) of carrying out the embodiments. This description is not to be taken in a limiting sense, but is made merely for the purpose of illustrating the general principles of the embodiment.

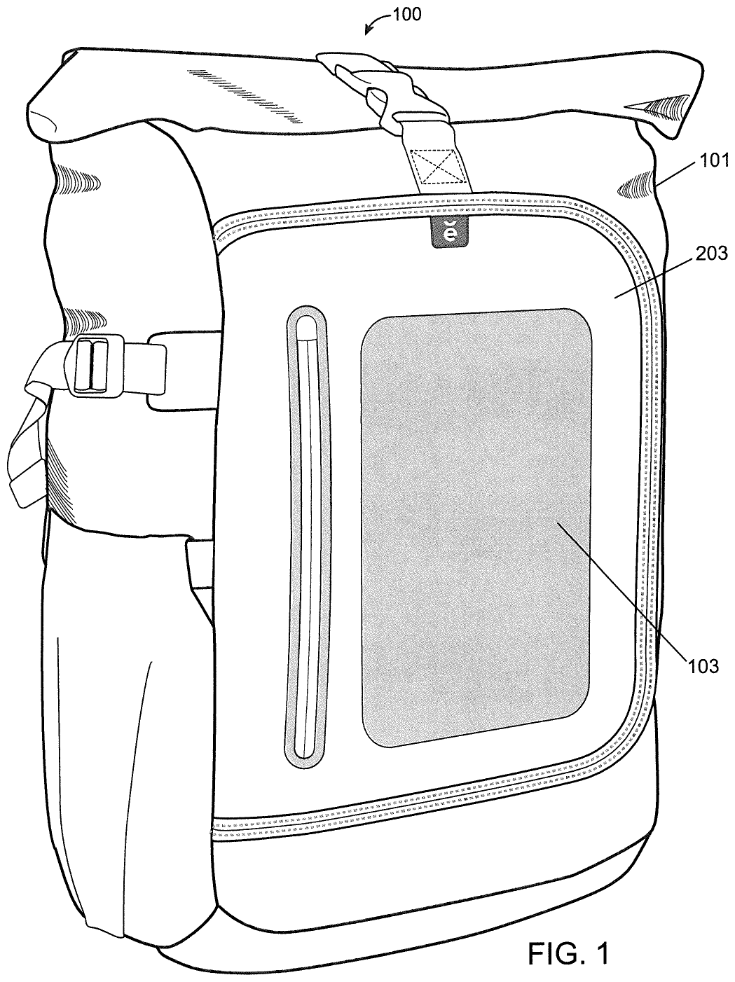

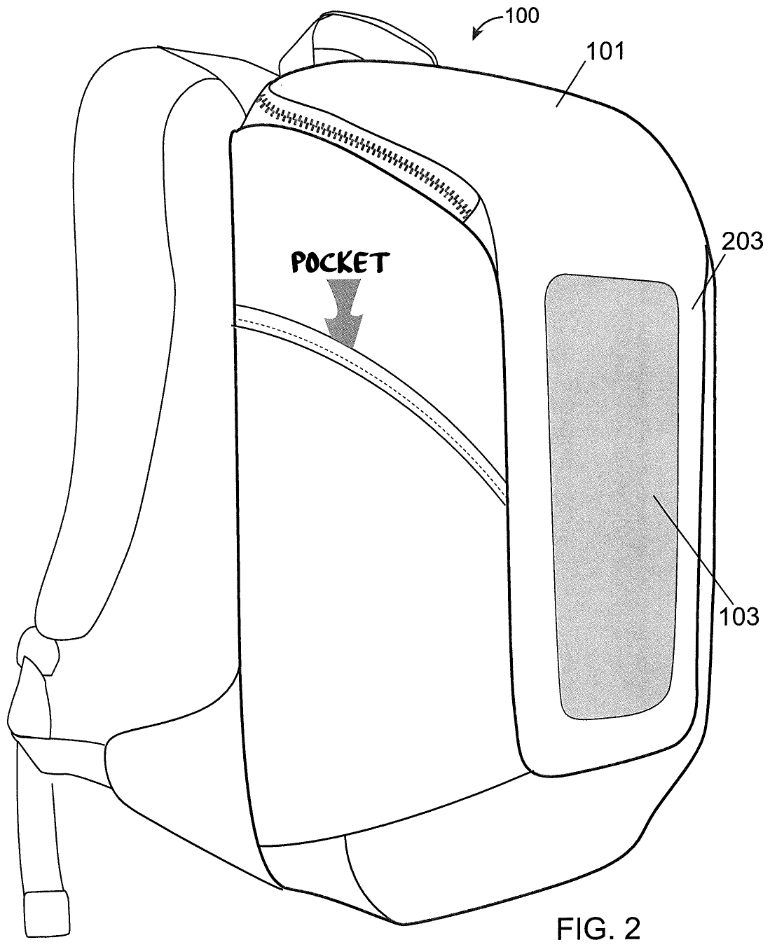

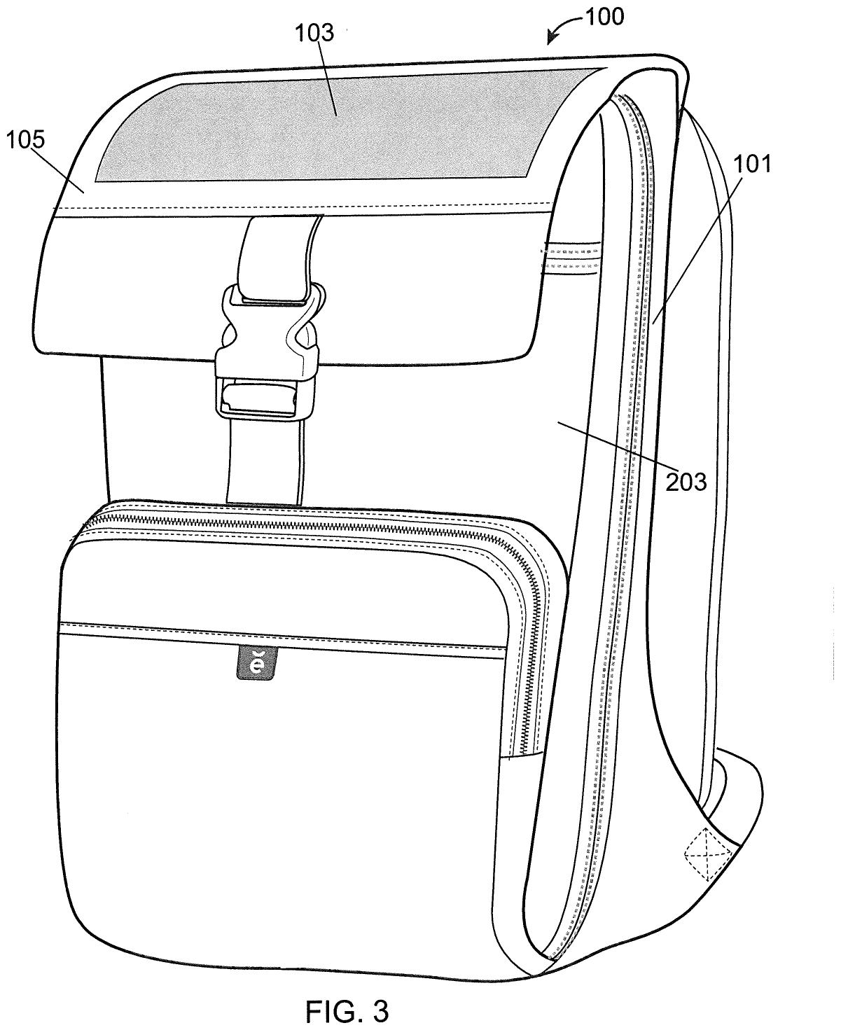

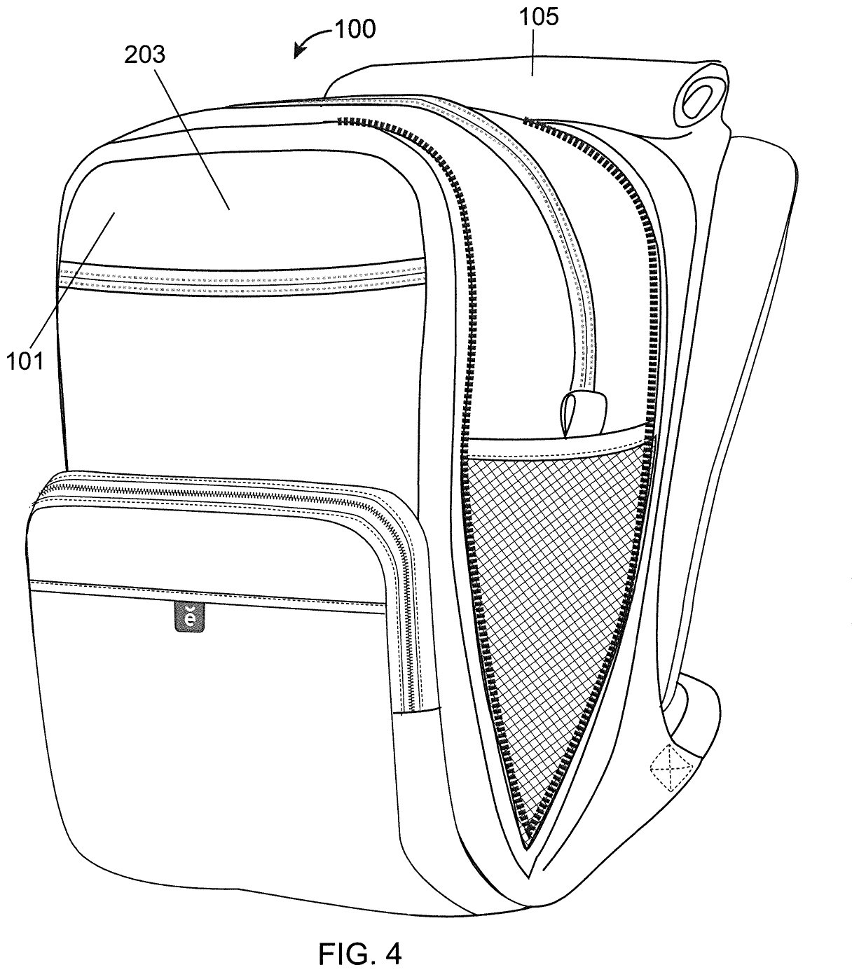

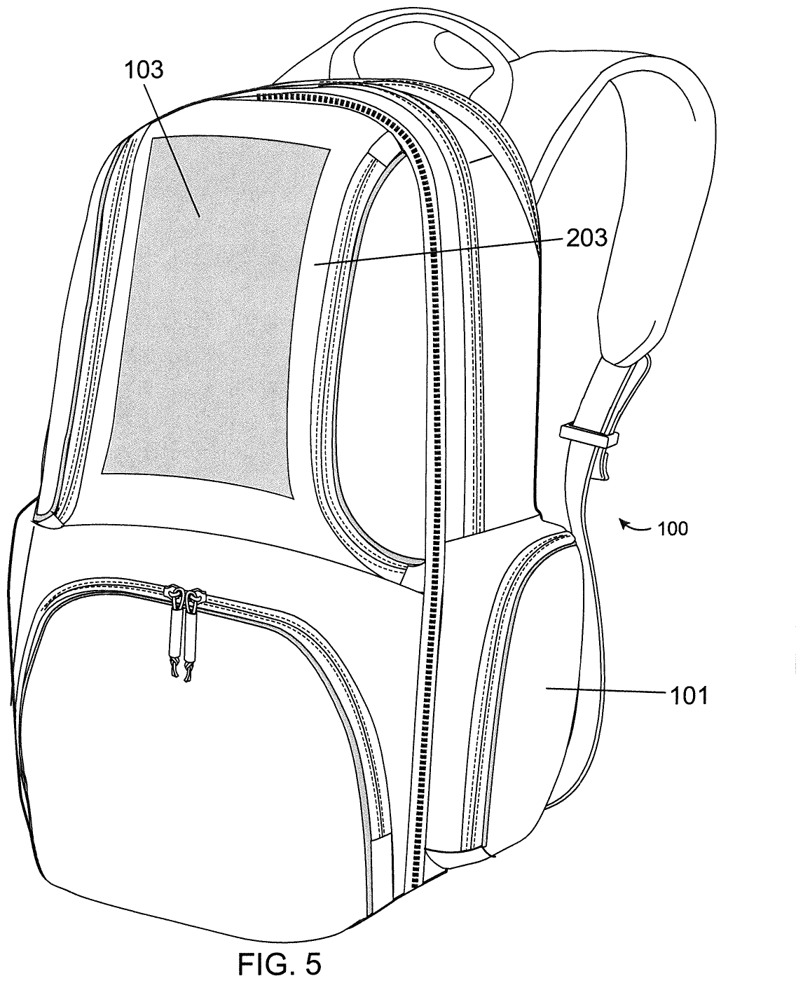

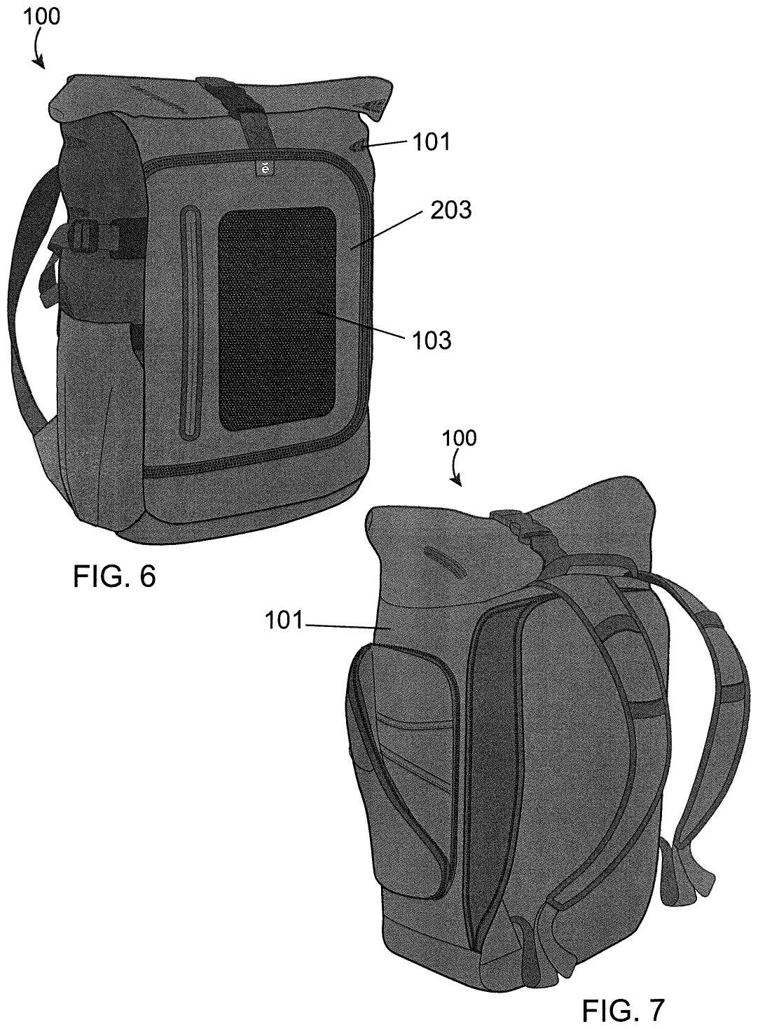

FIGS. 1-7 provide for a variety of embodiments of modular solar backpacks (100). Each is generally of loosely similar design and comprises a backpack body (101) and a flexible solar panel assembly (103) attached to the backpack (100). In the embodiments of FIGS. 1, 2, and 5-7, the solar panel (103) is attached to the generally front face (203) of the backpack (100). In the embodiment of FIGS. 3-4, the solar panel (103) is attached to a deployable panel (105) which can be rolled, as depicted in in FIG. 4, to stow the panel (103) or deployed to expose the panel (103), as depicted in FIG. 3. The solar panel (103) may be attached via any means, systems, or methods to the backpack body (101) but will generally be mechanically sewn into the fabric of the backpack body (101) or panel (105). Although the solar panel (103) will typically be flexible, in some embodiments, the solar panel (103) may be partially ridged.

The flexible solar panel (103) will preferably be able to be mechanically connected to an additional flexible solar panel (103) and/or to a chemical battery or other electrical storage means or system (not shown) which will generally be located within the backpack body. The solar panel (103) will typically be in electrical communication with any additional solar panel(s) (103) or battery via a wire or via wireless electrical communication means or systems. Typically, the connection will be through an interchangeable battery recharge cord in electrical communication with the battery for recharging at least one external apparatus. The battery will also typically be removable from the backpack body (101) for separate use and/or replacement. The backpack (100) will typically include a charge regulating circuit, as would be known to persons of ordinary skill in the art. Such a charge regulating circuit may be located in or on the battery or the solar panel (103). Alternatively, the charge regulating circuit may be located elsewhere, for example without limitation, the charge regulating circuit may be formed as a standalone circuit that is located within the backpack (100).

Each of the backpack bodies (101) is preferably made from environmentally friendly materials such as recycled plastics to further add to the sustainable nature of the backpack (100). The ability to provide and include additional mechanically attached additional flexible solar panels (103) to the backpack (100) allows for a user to deploy a first number of panels when the backpack is being worn and/or a second potentially different number of panels when the backpack is resting on the ground or otherwise not in use. Thus, the user can potentially obtain different speeds of electrical generation, as desired, depending on how the backpack (100) is being used and how much electricity is needed.

This ability to integrate additional flexible solar panels (103) into the backpack (100) means that, unlike a typical solar charger or solar power backpack, the addition of more flexible solar panels (103) to the product increases the recharge capacity and speed. This allows the user to securely carry and charge their electronic devices while moving, while also having the ability to unpack and setup the additional flexible solar panels to charge additional devices without compromising the recharge duration at a different time. One more of the additional flexible solar panels (103) may be stored in one or more pockets within the backpack (100). When two or more flexible solar panels (103), they may connected in series or in parallel. The two or more flexible solar panels (103) may be connected to a battery or to another electronic device.

The flexible solar panels (103), in an embodiment, use mono-crystalline silicon to provide efficient and lightweight portable solar sources to recharge batteries and other electronic devices equipment on the go. In some embodiments, such as the embodiment depicted in FIG. 1, the flexible solar panels (103) may have a generally rectangular shape having rounded corners. In other embodiments, the flexible solar panels (103) may have any general shape. The total backpack (100) system, in an embodiment, can generate up to 21 watts of power, enough to charge multiple electronic devices at the same time utilizing panels with the specifications shown in Table 1.

TABLE 1
Solar Panel Specifications:

| | |
|---|---|
| Panel Dimensions | ~300 × ~144 × ~2 mm |
| Substrate Type | PET/ETFE |
| Substrate Color | Black |
| Cell Type | Monocrystalline |
| Cell Efficiency | 18~20% |
| Peak Voltage | ≥7.79 V |
| Peak Current | ≥1170 mA |

According to an embodiment, the exterior of the modular solar power backpack body (100) may be made from a tough, 450-600D nylon and size 8-10 coil zippers. The interior portion of the modular solar power backpack body (100) may use ripstop fabric and may be padded with foam. The battery may be placed inside a pocket of the bag and typically can be removed and used separately and, in an embodiment, can have the characteristics shown in Table 2.

TABLE 2
Battery Specification:

| | |
|---|---|
| Input Power | Min. 5 V~Max. 20 V |
| Input Current | Max. 3000 mA |
| Battery Type | Li-Ion |
| Weight | 4-16 oz |

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

Finally, the qualifier “generally,” and similar qualifiers as used in the present case, would be understood by one of ordinary skill in the art to accommodate recognizable attempts to conform a device to the qualified term, which may nevertheless fall short of doing so. This is because terms such as “rectangular” are purely geometric constructs and no real-world component is a true “rectangular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric or other meaning of the term in view of these and other considerations.

1. A system for providing solar charging capabilities, the system comprising:
a backpack having a first pocket and an outer surface;
a first solar panel mounted onto the outer surface of the backpack;
a battery placed into the first pocket,
wherein the battery is configured to be electrically connected to more than a single solar panel.

2. The system of claim 1, the system further comprising a second solar panel, wherein the second solar panel is placed with a second pocket of the backpack.

3. The system of claim 2, wherein the system is configured so that the first solar panel and the second solar panel may be connected to the battery in series.

4. The system of claim 2, wherein the system is configured so that the first solar panel and the second solar panel may be connected to the battery in parallel.

5. The system of claim 2, wherein the first solar panel and the second solar panel are configured to supply power equal to or more than about 21 watts.

6. The system of claim 1, wherein the first solar panel is flexible.

7. The system of claim 1, wherein the first solar panel is mechanically sewn into the outer surface of the backpack.

8. The system of claim 1, wherein the battery is in wireless electrical communication with the first solar panel.

9. The system of claim 1, wherein the battery is in wired electrical communication with the first solar panel.

10. The system of claim 1, wherein the outer surface of the backpack is separable from the backpack.

11. The system of claim 1, further comprising a charge regulating circuit.

12. The system of claim 11, wherein the charge regulating circuit is located proximate to the battery.

13. The system of claim 11, wherein the charge regulating circuit is located proximate to the solar panel.

14. The system of claim 11, wherein the charge regulating circuit is located within the backpack.

15. The system of claim 1, wherein the battery is a chemical battery.

16. The system of claim 1, wherein the solar panel and the outer surface of the backpack are configured to allow for solar charging during use of the backpack.

17. The system of claim 16, wherein the solar panel may be hidden from view during use of the backpack.

18. The system of claim 17, wherein the solar panel may be hidden by rolling up the solar panel.

19. The system of claim 17, wherein the solar panel comprises mono-crystalline silicon.

20. The system of claim 1, wherein the backpack comprises a ripstop fabric.
